(19) United States
(12) Patent Application Publication
(10) Pub. No.: US 2007/0014205 A1
(43) Pub. Date: Jan. 18, 2007

(54) Objective lens holding device and usage thereof

(75) Inventor: Toshiharu Inui, Yamatokoriyama-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/482,656

(22) Filed: Jul. 6, 2006

(30) Foreign Application Priority Data
Jul. 8, 2005 (JP) 2005-200770

(51) Int. Cl. G11B 7/00

(52) U.S. Cl. 369/44.14

(57) ABSTRACT

The present invention relates to an objective lens holding unit which allows for accurate information reading and writing. In order to make it possible for a read/write device including an objective lens with a small working distance, particularly such as a BD-compliant read/write device, to perform accurate information reading and writing, the objective lens holding unit of the present invention includes two ribs provided on a surface of a lens holder facing an optical disk, the lens holder holding an objective lens, so as to sandwich the objective lens therebetween. On the surfaces of the ribs facing the optical disk, protectors are provided so as to project toward the optical disk more than the objective lens does.

This Nonprovisional application claims priority under 35 U.S.C. § 119(a) on patent application No. 200770/2005 filed in Japan on Jul. 8, 2005, the entire contents of which are hereby incorporated by reference.

### FIELD OF THE INVENTION

The present invention relates to an objective lens holding unit, an objective lens driving unit, an optical pickup device, and a read/write device, all of which are provided for reading and/or writing information from and/or onto an optical storage medium by means of light.

### BACKGROUND OF THE INVENTION

An optical pickup device is installed in an optical disk device (read/write device) which optically read and write information from and onto an optical disk (optical storage medium) such as CD (Compact Disk) and DVD (Digital Versatile Disk).

The optical pickup device adopts a tracking servo and a focusing servo to cause a beam spot of information reading/writing-use light, which is converted by an objective lens, to follow tracks which are formed helically or concentrically on a storage surface of an optical disk, so as to accurately read/write information.

In order to implement a tracking servo and a focusing servo, the optical pickup device installs an objective lens driving unit therein. In the objective lens driving unit, a movable part holding an objective lens is supported so as to be movable in a direction of an optical axis of the objective lens (focus direction) and a radial direction of the optical disk (tracking direction), and the movable part is arranged so as to be driven in the aforementioned directions by a driving section which is made up of magnets and coils.

In such a manner, the movable part is driven. This drives the objective lens in the focusing direction, thereby performing a focusing servo for bringing a beam spot to a focus on a storage surface of the optical disk. Meanwhile, the objective lens is driven in the radial direction of the optical disk, thereby performing a tracking servo for bringing a beam spot to a focus on a track of the storage surface of the optical disk.

In a situation where there occurs irregular following of the optical disk (control error caused by servo instability) due to disturbance such as an unexpected shock given to a read/write device, the objective lens and the optical disk abnormally come close to each other. This might cause contact and collision between the objective lens and the optical disk.

In order to avoid such possible contact, an objective lens holding unit has been proposed in which protectors are provided in the vicinity of an objective lens. The protectors protects an objective lens and an optical disk by avoiding a direct contact between the objective lens and the optical disk in such a manner that the protectors come into contact with the optical disk before the objective lens comes into contact with the optical disk.

For example, Patent document 1 (Japanese Unexamined Patent Publication No. 139694/2004 (Tokukai 2004-139694); published on May 13, 2004) describes an objective lens holding unit which includes two protectors, which are formed with a material softer than an objective lens and a lens holder, provided on both sides of the objective lens so as to sandwich an optical axis of the objective lens therebetween.

In recent years, there have been increasing demand for optical pickup devices provided for high density and high capacity. In response to such a demand, development of BD (Blu-ray Disk)-use optical pickups and the like have been advanced.

In optical disks, increase of storage capacity per unit area (storage density) can be realized by decrease in a diameter of a beam spot obtained from an optical pickup device. A smallest diameter of the beam spot is generally proportional to λ/NA (λ is a wavelength of a light source used, and NA is numerical apertures in an optical system) because of diffraction of light. It is known that the storage capacity can be increased by shortening a wavelength of a light source used or by increasing numerical apertures in an optical system of an optical pickup device.

Development of an optical pickup device using a blue semiconductor laser as a light source to shorten a wavelength of a light source has been advanced for its practical use.

Numerical apertures in an optical system of an optical pickup device, i.e. numerical apertures of an objective lens are set to be large, approximately 0.45 for CD, approximately 0.6 for DVD, and approximately 0.8 for BD. As numerical apertures increase, a working distance of an objective lens decreases. The working distance of an objective lens is a distance between an objective lens and an optical disk. For example, an optical pickup device for CDs has a working distance of approximately 1 to 1.2 mm, and an optical pickup device for DVDs has a working distance of approximately 0.6 mm. An optical pickup device for BDs has an extremely small working distance of approximately 0.1 to 0.3 mm.

In a read/write device provided for optical disks which needs a working distance of an objective lens, such as BD-capable read/write device, it is difficult to form lens protectors by fixing protector members separately formed onto a lens holder, unlike an objective lens driving unit described in Patent document 1.

In order to solve this problem, a technique of forming lens protectors by coating to avoid a direct contact between an objective lens and an optical disk and protect the objective lens and the optical disk has been proposed (For example, Patent document 2 (Japanese Unexamined Patent Publication No. 222535/2002 (published on Aug. 9, 2002)).

Conventionally, with the foregoing techniques, a position of the objective lens was controlled by a focusing servo and a tracking servo, and a contact between an optical disk and an objective lens was prevented by the foregoing lens protectors. In other words, with the foregoing techniques, a position of an objective lens with respect to an optical disk was controlled for realization of accurate information reading and writing.

However, these techniques had disadvantages such as insufficiently stable focusing servo and tracking servo, and made a read/write device to have an insufficient performance. In view of this, for realization of more accurate information reading and writing, there has been a strong demand for the development of a new technique.

### SUMMARY OF THE INVENTION

The present invention has been attained in view of the problems of the conventional techniques, and an object of the present invention is to provide (i) an objective lens holding unit capable of accurate information reading and writing, particularly, an objective lens holding unit capable of accurate information reading and writing even when it is used for a read/write device including an objective lens with a small working distance, and (ii) use thereof.

In order to solve the problem, an objective lens holding unit of the present invention is an objective lens holding unit including: a lens holder which holds an objective lens so that the objective lens faces an optical storage medium, the objective lens converging light emitted from a light source onto the optical storage medium; and protectors which are provided so that surfaces of the protectors facing the optical storage medium are closer to the optical storage medium than the objective lens is, wherein: at least two ribs are provided on a surface of the lens holder facing the optical storage medium so as to sandwich the objective lens therebetween; and the protectors are provided on surfaces of the ribs facing the optical storage medium.

According to the above arrangement, the ribs provided on the surface of the lens holder facing the optical storage medium increases a stiffness of the objective lens holding unit. This increases a resonance frequency in a movable part including the objective lens holding unit. With the increase of resonance frequency in the movable part, it is possible to obtain more stable focusing servo and tracking servo.

Particularly, a read/write device for BDs, or a read/write device for high-speed DVDs having an objective lens with a small working distance and having large numerical apertures requires a high servo band. That is such a read/write device requires focusing servo and tracking servo with stability and high precision, and cannot read and write if focusing servo or tracking servo becomes unstable.

As described previously, the objective lens holding unit of the present invention can enhance stability of focusing servo and tracking servo, and therefore allows for accurate and stable information reading and writing even in a read/write device having an objective lens with a small working distance.

As described above, since the ribs increases a stiffness of the lens holder, weight reduction of the lens holder is possible by removing an unwanted part (excess part) of the lens holder. Weight reduction of the lens holder causes the weight reduction of the objective lens holding unit, resulting in increase in driving sensitivity of an objective lens driving unit. The increase in driving sensitivity means that only a small amount of currents is required in moving the objective lens holding unit. That is, the objective lens holding unit of the present invention makes it possible to reduce power consumption of the objective lens driving unit.

If an attempt for the weight reduction was made by trimming the lens holder with the use of the conventional objective lens holding unit, a stiffness of the lens holder would decrease. This causes the aforementioned problem, i.e. unstable focusing servo and tracking servo.

That is, the objective lens holding unit of the present invention includes the ribs, thereby enabling compatibility between stiffness and weight reduction, which was impossible in the past. Thus, the objective lens holding unit of the present invention allows for accurate information reading and writing in a read/write device.

In addition, the lens holding unit of the present invention includes the protectors, and can therefore prevent a contact between the objective lens and the optical storage medium. In other words, the protectors serve as lens protectors to protect the objective lens and the optical disk from being scratched due to a contact between the objective lens and the optical storage medium. Thus, it is possible to perform accurate and stable information reading and writing.

Further, the protectors can be made smaller by providing the protectors on the surfaces of the ribs facing the optical storage medium than by providing the protectors as lens protectors at different positions from the positions of the ribs. This makes it possible to make the objective lens holding unit lighter and smaller. This brings the effect of further enhancing a driving sensitivity, as described previously.

In order to solve the above problem, it is preferable that an objective lens driving unit of the present invention includes the foregoing objective lens holding unit, and further includes a movable part which is supported so as to be movable in at least two directions, focusing direction and tracking direction, with respect to the optical storage medium; and a driving section which causes the movable part to move in at least the two directions.

According to the above arrangement, the objective lens driving unit includes the objective lens holding unit, and therefore is excellent in driving sensitivity and stability of focusing servo and tracking servo. Thus, the foregoing objective lens driving unit can perform accurate and stable information reading and writing.

In addition, the present invention further includes (a) an optical pickup device including the forgoing objective lens driving unit and (b) a read/write device including the optical pickup device.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is an oblique perspective view illustrating a movable part of the present embodiment when viewed from the optical disk side.

FIG. 2 is a plan view illustrating a movable part of the present embodiment when viewed from the optical disk side.

FIG. 3. is a cross-sectional view of a movable part 8 taken on X-X′ of FIG. 2.

FIG. 4 is a cross-sectional view of the movable part 8 taken on Y-Y′ of FIG. 2.

FIG. 5 is a cross-sectional view of the movable part 8 taken on Y-Y′ of FIG. 2.

FIG. 6 is a plan view of a masking jig of the present embodiment.

FIG. 7 is a cross-sectional view schematically illustrating a read/write device of the present embodiment.

FIG. 8 is an oblique perspective view of a movable part as a comparative example when viewed from the optical disk side.

FIG. 9 is a plan view of a movable part as a comparative example when viewed from the optical disk side.

FIG. 10 is a plan view of a masking jig as a comparative example.

### DESCRIPTION OF THE EMBODIMENTS

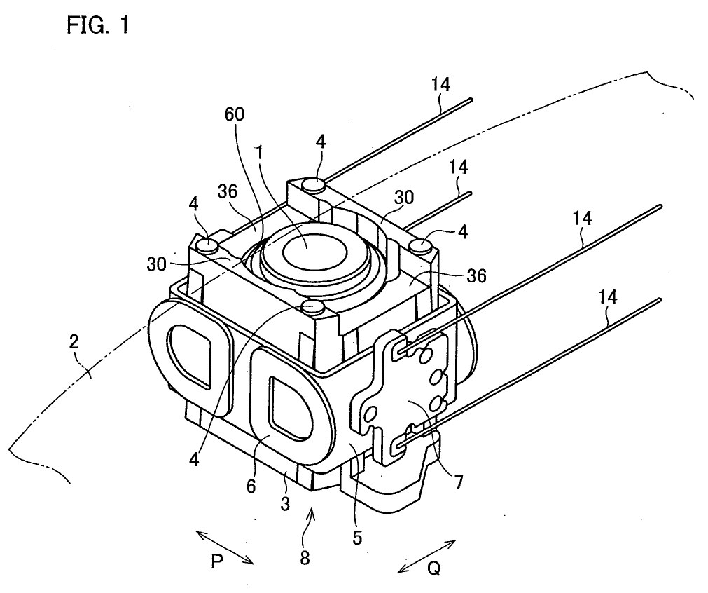

The following will describe an optical pickup device and a read/write device according to the present embodiment with reference to FIGS. 1 through 10.

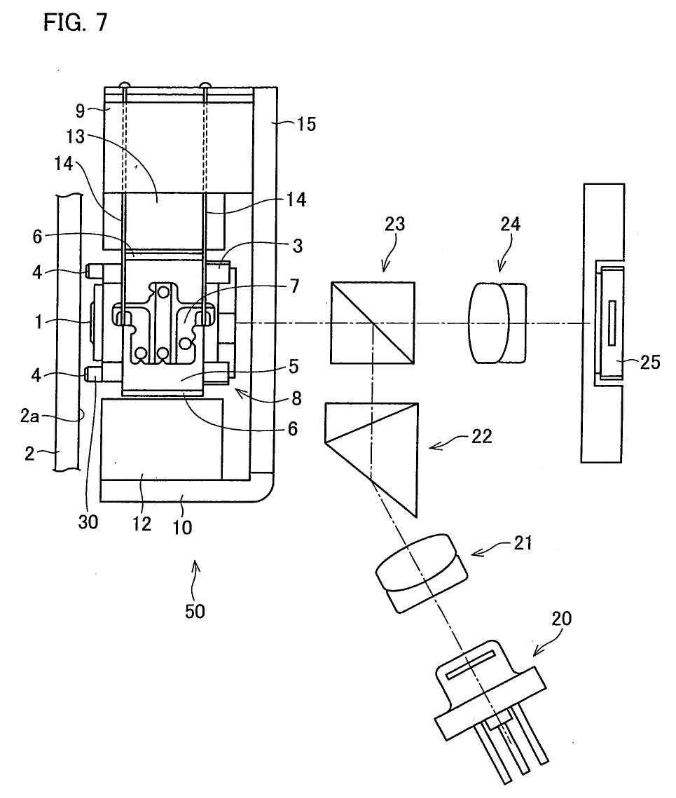

FIG. 7 is a cross-sectional view schematically illustrating a read/write device according to the present embodiment.

The read/write device of the present embodiment includes: an optical pickup device which scans a track formed on an optical disk (optical storage medium) 2 with irradiated light (light) so as to perform information reading and/or writing; and a disk rotation device (not shown) which rotates the optical disk 2 in response to the irradiated light emitted from the optical pickup device.

The optical disk 2 which the read/write device according to the present embodiment reads from and/or writes onto is not limited if the optical disk 2 is a medium which information is read from or written on by means of light. The optical disk 2 includes a magneto-optic disk or the like. Examples of the optical disk 2 include an optical disk in a flat and circular shape, such as CD, DVD, or BD.

The read/write device of the present embodiment, which is not limited to, is a read/write device which rotates the optical disk 2 as described previously. Alternatively, the read/write device of the present embodiment may be a device which can change a position where light strikes on the optical disk 2 so as to read and/or write information.

Next, the optical pickup device is described below. The optical pickup device of the present embodiment is an optical pickup device which performs at least either information writing onto an optical disk or information reading from an optical disk. The optical pickup device includes a light source which emits light and an objective lens, and further includes: light converging means which converges light emitted from the light source onto an information storage surface of the optical disk; an objective lens driving unit; and light detection means which detects light which is converged by the light converging means and reflected by the optical disk.

A structure of the optical pickup device is described in detail below. The optical pickup device of the present embodiment includes a light source 20, light detection means 25, and light converging means (1, 21 through 24). The light source 20 emits light to the optical disk 2. The light detection means 25 detects light reflected by the optical disk 2. The light converging means (1, 21 through 24) which guides light emitted from the light source 20 onto the optical disk 2 and guides light reflected by the optical disk 2 to the light detection means 25.

As illustrated in FIG. 7, the light converging means includes a collimating lens 21, a prism 22, a polarizing beam splitter 23, and an objective lens 1 in this order when viewed from the light source 20 toward the optical disk 2. Moreover, the light converging means further includes another collimating lens 24 between the polarizing beam splitter 23 and the light detection means 25.

The light emitted from the light source 20 is turned into parallel light by the collimating lens 21. Thereafter, the parallel light passes through the beam splitter 23 which split incoming light and reflected light, passes through the objective lens 1, and comes into a focus on a track of the optical disk 2.

Meanwhile, the light reflected by the optical disk 2 passes through the objective lens 1 and enters the polarization beam splitter 23, and is guided by the polarization beam splitter 23 to the collimating lens 24 side. The collimating lens 24 converges the reflected light on the light detection means 25, and the light detection means 25 detects the reflected light. The light detection means 25 has a light receptor (optical sensor). The light receptor detects the reflected light converged by the collimating lens 24.

It is to be noted that the light converging means may include a diffraction grating, a ¼ wavelength plate, a cylindrical lens, and others when necessary, as well as the foregoing members. The light source 2, the light detection means 25, and various devices not shown but included in the optical pickup device and the. read/write device are not particularly limited, and can be realized by conventionally known devices.

In order to meet a demand for a high storage density, the objective lens 1 according to the present embodiment is an objective lens having a large NA so as to be capable of focusing a light beam to a small cross section.

As illustrated in FIG. 7, the optical pickup device of the present embodiment further includes an objective lens driving unit 50. The objective lens driving unit 50 includes an objective lens holding unit and a driving section. The driving section shifts the objective lens holding unit in at least a radial direction of the optical disk 2 (tracking direction) and a direction of an optical axis of the objective lens 1 (focusing direction).

The objective lens holding unit includes a lens holder 3 and a protector 4. The lens holder 3 holds the objective lens 1 in such a manner that the objective lens 1 faces the optical disk 2. The protector 4 has a surface facing an optical storage medium, and the surface is provided closer to the optical disk 2 than the objective lens 1 is. Details of the objective lens holding unit will be described later.

The objective lens driving unit 50 is a device which performs focusing adjustment and tracking adjustment of light exposed onto the optical disk 2. Specifically, by shifting the objective lens holding unit in accordance with a result of laser beam detection performed by the light detection means 25, the objective lens driving unit 50 shifts (performs displacement drive) the objective lens 1 in both a focusing direction and a tracking direction with respect to a storage surface 2a of the optical disk 2, so that light emitted from the light source 20 comes into a focus on a track of the optical disk 2.

The objective lens driving unit 50 includes the foregoing lens holding unit, and further includes the driving section. The driving section includes drive coils (focusing coil 5 and tracking coils 6), magnets (first magnet 12 and second magnet 13) provided so as to face these drive coils, and yokes (first yoke 10 and second yoke (not shown)).

More specifically, the objective lens driving unit 50 includes: a base part 15 in a plate shape; and a supporter 9 provided on the side of the base part 15 facing the optical disk 2. Further, the first yoke 10 and the second yoke are provided so as to be opposed from each other in a scanning direction. The second yoke is provided at a position such that the second yoke is axisymmetric to the first yoke 10 about an optical axis of the objective lens 1 (In FIG. 7, at a position hidden behind the supporter 9). Further, the first magnet 12 and the second magnet 13 are fixed to the first yoke 10 and the second yoke, respectively, so as to be opposed from each other in the scanning direction. A movable part 8 including the objective lens holding unit so as to be sandwiched between the first magnet 12 and the second magnet 13 is provided. In other words, the first magnet 12 and the second magnet 13 are arranged across the movable part 8 in the scanning direction. Further, the movable part 8 is held by the supporter 9 via an elastic support member 14.

The first yoke 10 and the second yoke 11 are members which are in the shape of a rectangular flat plate and are made of a ferromagnetic material. The first yoke 10 and the second yoke 11 are formed at ends of the base section 15 by bending process. The first magnet 12 and second magnet 13 are pieces of permanent magnets each of which has been magnetized in a radial direction of the optical disk 2 to have a north pole and a south pole.

The following will describe the movable part 8 with reference to FIGS. 1, 2, and 7.

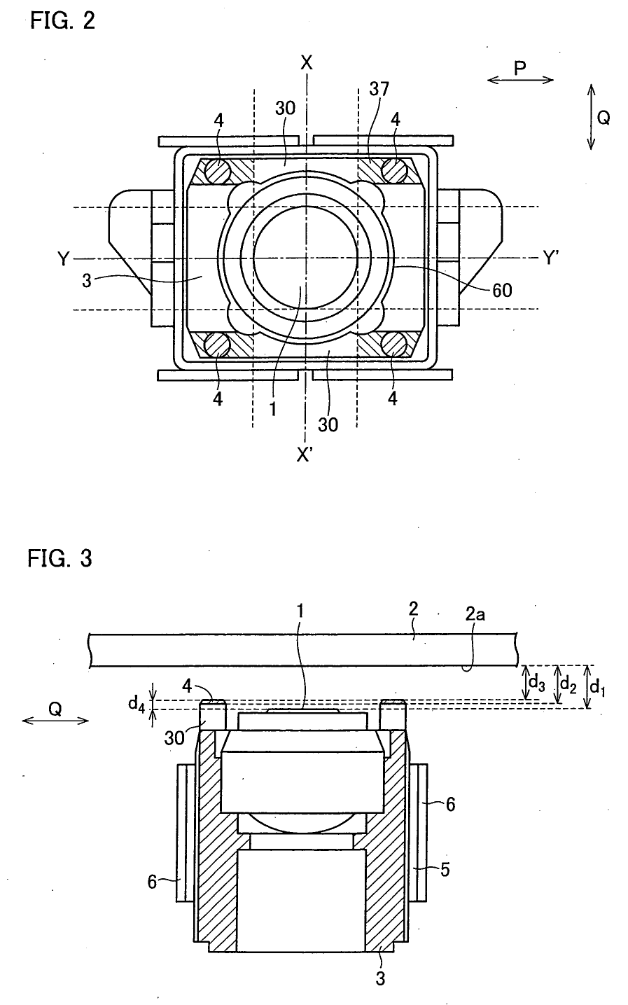

FIG. 1 is an oblique perspective view of the movable part 8 when viewed from the optical disk 2 side. FIG. 2 is a plan view of the movable part 8 and its surroundings when viewed from the optical disk 2 side.

Note that an arrow P represents a radial direction of the optical disk 2 (direction perpendicular to a scanning direction of light), and an arrow Q represents a direction tangential to an outer edge of the optical disk 2 (scanning direction of light).

As illustrated in FIGS. 1 and 7, the movable part 8 includes: the objective lens 1; the objective lens holding unit (3, 4) which includes the lens holder 3 holding the objective lens 1; the coils (5, 6) provided on a side surface of the lens holder 3 (surface perpendicular to the optical disk 2); and a substrate 7. It is to be noted that the objective lens 1 is fixed to a lens mounted area 60 with an adhesive such as ultraviolet curing adhesive. The lens mounted area 60 is provided on a surface of the lens holder 3 facing the optical disk 2.

The focusing coil 5 is wound around the lens holder 3 about an axis which is a direction perpendicular to a storage surface of the optical disk 2. Accordingly, as is the case with the lens holder 3, the focusing coil 5 is formed so as to be substantially rectangular in shape in cross section which is parallel to the optical disk 2. The focusing coil 5 is arranged in such a manner that surfaces of the focusing coil 5 perpendicular to the scanning direction Q face the first magnet 12 and the second magnet 13.

The tracking coils 6 are wound about an axis which is a scanning direction, and is formed so as to be substantially in the form of the letter D in cross section which is perpendicular to the axis. Further, two tracking coils 6 are arranged on each of the surfaces of the focusing coil 5 facing the first magnet 12 and the second magnet 13 in such a manner so as to be connected in series. That is, a total of four tracking coils 6 are arranged on the focusing coil 5. The coils are bonded and fixed with a thermosetting adhesive or the like after the coils are inserted in such a direction that the objective lens 1 is mounted onto the lens holder 3.

Further, the movable part 8 has two substrates 7 provided respectively on side surfaces of the focusing coil 5 along the tracking direction (both sides in a direction indicated by the letter P). One ends of the foregoing elastic support members 14 are mechanically and electrically connected to the substrate 7 by means of soldering or others. That is, the elastic support member 14 connects the movable part 8 to the supporter 9 via the substrate 7. Further, the substrate 7 supplies power to the coils (5, 6) via the elastic support member 14.

The elastic support member 14 is a member having elasticity, and is connected to the supporter 9 and the lens holder 3, as described above. The movable part 8 is movable with respect to the supporter 9 by elasticity of the elastic support member 14. That is, the movable part 8, i.e. the lens holding unit is held so as to be movable in focusing and tracking directions with respect to the optical disk 2. The elastic support member 14 can be a wire material which is substantially circular in cross section. In the present embodiment, the elastic support member 14 is formed with a phosphor bronze wire approximately 0.1 mm in diameter, and four elastic support members 14 are provided, wherein two elastic support members 14 are provided on each of the surfaces of the movable part 8 along the tracking direction in such a manner so as to be away from each other along the focusing direction. The other ends of the elastic support members 14 are connected to the supporter 9. Thus, the lens holder 3 (movable part 8) is held by the elastic support member 14 in a cantilever manner. Two of the four elastic support members 14 are connected to the focusing coil 5, and the other two of the four elastic support members 14 are connected to the tracking coil 6. With this arrangement, the passage of currents through the focusing coil 5 and the tracking coil 6 allows for independent driving in the focusing direction and the tracking direction.

At the time of focus correction operation (focus adjustment), the foregoing objective lens driving unit 50 moves the movable part 8 in the focusing direction (a direction perpendicular to the storage surface of the optical disk 2, a direction of an optic axis of the objective lens 1) by means of a magnetic circuit constituted by the focusing coil 5, the first magnet 12 and the second magnet 13 both of which generate magnetic fields, the first yoke 10, and the second yoke 11. At the time of tracking correction operation (tracking adjustment), the foregoing objective lens driving unit 50 moves the movable part 8 in the tracking direction (a direction parallel to the storage surface 2a of the optical disk 2) by means of a magnetic circuit constituted by the tracking coil 6, the first magnet 12 and the second magnet 13 both of which generate magnetic fields, the first yoke 10, and the second yoke 11.

The lens holder 3 is substantially rectangular in cross section parallel to the optical disk 2 and holds the objective lens 1 on a side thereof facing the optical disk 2. The lens holder 3 is preferably made of a material having a significant effect of vibration isolation of vibrations given from the outside of the movable part 8, i.e. a material excellent in attenuation properties. Examples of such a material include liquid crystal resin (Liquid Crystalline Polymer: LCP).

The objective lens holding unit includes the lens holder 3 and the protectors 4. The objective lens holding unit of the present embodiment includes two ribs 30 provided on a surface of the lens holder 3 facing the optical disk 2, so as to sandwich the objective lens 1 therebetween.

As illustrated in FIG. 1, the ribs 30 are provided in such a manner that their longer sides are substantially perpendicular to the outer edge of the optical disk 2. More specifically, the surface of the lens holder 3 facing the optical disk 2 is rectangular, and two sides of the lens holder 3 are provided so as to be perpendicular to a tangential direction to the outer edge of the optical disk 2 (direction indicated by an arrow Q in FIG. 1). The ribs 30 are provided along the two sides perpendicular to the tangential direction.

Each of the ribs 30 is provided continuously extending from one end to the other end of the side of the lens holder 3. That is, each of the ribs 30 is provided continuously extending from one end to the other end of the surface of the lens holder 3 facing the optical disk 2.

Further, an area provided between the ribs 30, i.e. an area which is provided outside the objective lens 1 on the surface of the lens holder 3 facing the optical disk 2 and sandwiched between the ribs 30 (area indicated by reference numeral 36 in FIG. 1) is provided so as to be in a lower level than the surfaces of the ribs 30 facing the optical disk 2 and than a top of the objective lens 1 (on the surface of the objective lens 1 facing the optical disk 2). That is, the area 36 is provided further away from the optical disk 2 than the objective lens 1 is.

Still further, the surfaces of the ribs 30 facing the optical disk 2 are provided between the optical disk 2 and the top of the objective lens 1.

Further, the protectors 4 of the present embodiment are coating layers provided by coating and provided at both ends of the rib 30.

The objective lens holding unit according to the present embodiment, as described previously, includes at least two ribs 30 provided on the surface of the lens holder 3 facing the optical disk 2, so as to sandwich the objective lens 1 therebetween.

According to the above arrangement, provision of the ribs 30 reinforces the lens holder 3 and improves stiffness of the lens holder 3. Thus, removing an unwanted excess part of the lens holder 3 does not lower the stiffness. That is, it is possible to reduce weight by removing an unwanted excess part of the lens holder 3.

Weight reduction of the lens holder 3 reduces weight of the objective lens holding unit, resulting in weight reduction of the entire movable part 8. This improves a driving sensitivity of the objective lens driving unit 50. In other words, it becomes possible to move the movable part with lower currents. This makes it possible to reduce power consumption of the objective lens driving unit 50.

In a lens holder provided by the conventional technique, removing unwanted excess part of the lens holder decreases stiffness of the lens holder. Decrease in stiffness of the lens holder decreases a resonance frequency of the entire movable part 8. As described previously, an optical pickup device of the present embodiment performs tracking adjustment and focus adjustment by a tracking servo and focusing servo, respectively, by driving the movable part 8. However, decrease in resonance frequency of the movable part 8 makes it impossible to obtain stable tracking servo and focusing servo. Particularly, stable tracking servo and focusing servo are needed in (i) a read/write device dealing with a BD having a small working distance of the objective lens and a high numerical aperture of the objective lens or (ii) a read/write device dealing with a high-speed DVD which needs a high servo band due to a high revolution speed (linear velocity) of an optical disk caused by high speed reading and writing. Particularly, in such a read/write device, unstable tracking servo and focusing servo particularly make it impossible to perform reading and writing.

On the contrary, since the lens holder 3 of the present embodiment includes the ribs 30, as described previously, stiffness of the lens holder 3 is maintained even when unwanted excess part of the lens holder 3 is removed. Thus, it is possible to realize stable focusing servo and tracking servo. In other words, an objective lens holding unit of the present invention allows a read/write device to accurately and stably read and write information.

Note that the ribs 30 of the present embodiment are, as illustrated in FIG. 1, provided continuously extending from one end to the other end of the surface of the lens holder 3 facing the optical disk 2. However, the present invention is not limited to this arrangement. That is, in the present invention, the ribs are not particularly limited in terms of their shape or other aspects, as long as the ribs are projections which are integral with the lens holder and can improve stiffness of the lens holder. However, for enhancement of stiffness of the lens holder, it is preferable that the ribs are larger in diameter than the objective lens. Further, as with the ribs 30 of FIG. 1, the arrangement in which the ribs are provided so as to continuously extend from one end to the other end of the lens holder 3 brings the effect of further enhancing stiffness of the lens holder 3.

Note that width of shorter sides of the ribs 30 is not particularly limited, as long as the shorter sides are wide enough to have the protectors 4 on the ribs 30.

The protectors 4 are provided on the surfaces of the ribs 30 facing the optical disk 2, and the surfaces of the protectors 4 facing the optical disk are provided closer to the optical disk 2 than the objective lens 1 is. With the above arrangement, the protectors 4 can prevent the optical disk 2 and the objective lens 1 from coming into contact with each other, without scratching the optical disk 2. Prevention of the contact between the optical disk 2 and the objective lens 1 by the protectors 4 will be described later.

Further, the protectors 4 provided on the ribs 30 can make the objective lens holding unit lighter and smaller than the protectors 4 provided at any positions other than the positions of the ribs 30.

In the present embodiment, the protectors 4 are provided at both ends of the ribs 30. However, the present invention is not limited to this arrangement. The protectors 4 may be provided anywhere on the surfaces of the ribs 30 facing the optical disk 2. The protectors 4 may be provided over the entire surfaces of the ribs 30. The protectors 4 of the present embodiment bring the effects described later when the protectors 4 are provided at both ends of the ribs 30.

It is preferable that material for the protectors 4 has elasticity and/or flexibility to such a degree that no damage to the optical disk 2 even when the protectors 4 come into contact with the optical disk 2. It is suitable that the material for the protectors 4 is a material having a low coefficient of friction in order to avoid the elastic support members 14 supporting the movable part 8 from deforming due to entangling or factors which occurs when the optical disk 2 and the protectors 4 come into contact with each other.

Apart from the foregoing materials, it is possible to suitably adopt a material used in the conventional lens protectors. As a method for providing the protectors 4, coating is preferable as in the present embodiment. However, the present invention is not limited to this. The reason why coating is preferable will be described later.

As illustrated in FIG. 1, an objective lens holding unit of the present embodiment is arranged such that longer sides of the ribs 30 are provided so as to substantially perpendicular to a tangential direction to the outer edge of the optical disk 2, and such that the protectors 4 are provided on the surfaces of the ribs 30 facing the optical disk 2.

Conventionally, in optical pickup devices, focusing and tracking frequency properties (which may be simply referred to as frequency properties) of the objective lens driving unit 50 are measured. For the measurement of such frequency properties, a laser Doppler device is used. For an accurate measurement of tracking frequency properties, it is preferable to directly apply laser beams to the objective lens in a radial direction of the optical disk, i.e. in a direction perpendicular to the scanning direction.

However, in the objective lens holding unit including circular lens protectors surrounding the objective lens (see Patent document 2), the lens protector cuts off laser beams entering from a radial direction of the optical disk. Therefore, the objective lens cannot be directly irradiated with laser beams. For this reason, the optical pickup device including such a lens protector applies laser beams onto a side surface of the lens holder so as to measure frequency properties. In such an optical pickup device might measure modified frequency properties of the lens holder, which are irrelevant to the foregoing frequency properties. Since the frequency properties of the objective lens driving unit 50 cannot be separated from the modified frequency properties, it is impossible to measure accurate frequency properties. This makes it impossible to accurately evaluate tracking frequency properties, resulting in the problem that reading and writing capabilities of the objective lens drive unit cannot be determined accurately.

As described previously, an objective lens holding unit of the present embodiment is arranged such that the longer sides of the ribs 30 are provided so as to be substantially perpendicular to a tangential direction to the outer edge of the optical disk 2, and such that the protectors 4 are provided on the surfaces of the ribs 30 facing the optical disk 2.

More specifically, the protectors 4 are provided at positions displaced from at least one of areas which extend on both sides with respect to the objective lens 1 along a radius (P direction) of the optical disk 2. That is, it is preferable that the protectors 4 are not provided on at least either inside or outside of the optical disk 2 with respect to the objective lens 1. In other words, an optical path along which a laser beam can be applied on the objective lens 1 is provided in at least one position in a radial direction of the optical disk 2 with respect to the objective lens 1.

This arrangement makes it possible to view the objective lens 1 from a radial direction of the optical disk 2, i.e. to directly apply laser beams onto the objective lens 1 from a radial direction of the optical disk 2. As a result of this, tracking frequency properties of the objective lens driving unit 50 can be accurately measured and evaluated, which therefore makes it possible to accurately read and write information. It is to be noted that measurement of frequency properties is possible as long as 1 to 2 mm of the side surface of the objective lens is visible.

Further, in an objective lens holding unit of the present embodiment, the protectors 4 are provided at both ends of the longer sides of the ribs 30. With this arrangement, the protectors 4 are provided away from the objective lens 1 and a lens mounted section 60. The wording “provided away from . . .” means to provide at a distance from the objective lens 1 and the lens mounted section 60 on a flat surface parallel to the storage surface 2a.

With this arrangement, even when the contact between the optical disk 2 and the objective lens holding unit due to control error caused by servo instability brings the protectors 4 into contact with the optical disk 2, the event is less likely to occur that portions of the protector 4 come off due to the contact with the optical disk 2 (broken pieces of the protectors) might be attached onto the surface of the objective lens 1, particularly onto the area extending from a center of the objective lens to a diameter of an effective light flux area. As a result, outgoing light from the objective lens 1 and incoming light to the objective lens 1 are not cut off due to the broken pieces of the protectors. This makes it possible to perform stable and excellent reading and writing.

More specifically, it is preferable that, as illustrated in FIG. 2, the ribs 30 are formed in such a manner that longer sides of the ribs 30 are parallel to tangents (indicated by dotted lines in FIG. 2) of an effective diameter of the objective lens 1, and that the both ends of the longer sides of the ribs 30 has projected regions 37 which project outward beyond the lens holder 3 and are outside an the effective diameter area of the objective lens 1. The protectors 4 are provided inside the projection regions 37 so as to be away from the objective lens 1 and the lens mounted section 60. It is to be noted that the protectors 4 are provided in outer regions of the lens holder 3 with respect to the tangents (indicated by dotted lines in FIG. 2) of the effective diameter of the objective lens 1 which are perpendicular to the longer sides of the ribs 30.

The arrangement in which the protectors 4 are provided away from the objective lens 1 has advantages at the time when the protectors 4 come into contact with an edge of the optical disk 2 and at the time when the protectors are formed. These advantages will be described later.

Next, referring to FIGS. 3 through 5, the present embodiment will be discussed in still greater detail below.

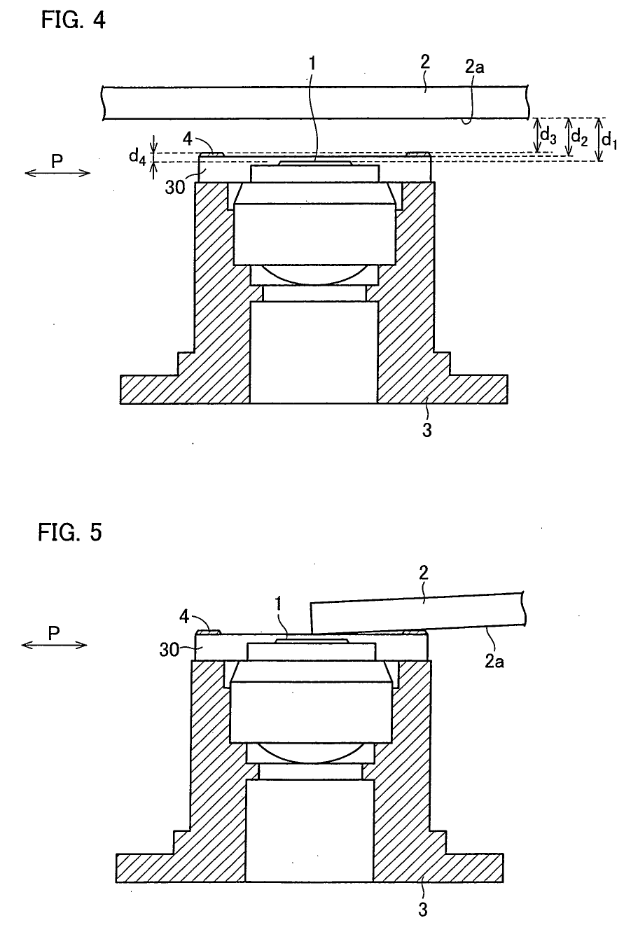

FIG. 3 is a cross-sectional diagram of the movable part 8 taken on line X-X′ of FIG. 2. FIGS. 4 and 5 are cross-sectional diagrams of the movable part 8 taken on line Y-Y′ of FIG. 2.

As illustrated in FIG. 3, the protectors 4 of the present embodiment are provided in such a manner that the surfaces of the protectors 4 facing the optical disk 2 are closer to the optical disk 2 than the object lens 1 is.

That is, distance d1 between the objective lens 1 and the optical disk 2 and distance d3 between the protectors 4 and the optical disk 2 have a relation of d1>d3. With this arrangement, even when the optical disk 2 and the objective lens 1 come close to each other due to the occurrence of servo instability, the protectors 4 rather than the objective lens 1 comes into contact with the optical disk 2. This prevents the contact between the objective lens 1 and the optical disk 2. Since the protectors 4 are formed with a material having a low coefficient of friction and/or being more flexible than the optical disk 2, the protectors 4 gives no damage to the optical disk even when the protectors 4 come into contact with the optical disk.

It is to be noted that the distance refers to a shortest distance between two objects. That is, a distance between the objective lens 1 and the optical disk 2 refers to a shortest distance between the objective lens 1 and the optical disk 2.

Further, in the present embodiment, as illustrated in FIGS. 3 and 4, the surfaces of the ribs 30 facing the optical disk 2 are provided between the surface of the objective lens 1 facing the optical disk 2 and the optical disk 2. That is, the ribs 30 are provided so as to project toward the optical disk 2 more than the objective lens 1 does. Therefore, the distance d1 between the objective lens 1 and the optical disk 2, the distance d2 between the ribs 30 and the optical disk 2, the distance d3 between the protectors 4 and the optical disk 2 have a relation of d1>d2>d3.

That is, the surfaces of the ribs 30 facing the optical disk 2 and the surfaces of the protectors 4 facing the optical disk 2 are provided in a working distance d1 of the objective lens 1 (distance between the optical disk 2 and the objective lens 1). In the present example, a working distance (distance d1) of the objective lens is 0.26 mm. A distance from the objective lens 1 to the surfaces of the ribs 30 facing the optical disk 2 is approximately 0.08 mm. A distance (d4) from the objective lens 1 to the faces of the protectors 4 facing the optical disk 2 is set to approximately 0.16 mm.

The effects brought by the lens holding unit of the present embodiment will be described with reference to FIG. 5.

The ribs 30 are provided in such a manner that the longer sides thereof are substantially perpendicular to the outer edge of the optical disk 2 and that the longer sides thereof are longer than an effective diameter of the objective lens 1. That is, as illustrated in FIGS. 1 and 5, when the outer edge of the optical disk 2 passes above the objective lens 1, the line of the outer edge of the optical disk 2 passes between one end of the longer side of the rib 30 and the other end.

As illustrated in FIG. 5, assume that the optical pickup device moves to the outside of the optical disk 2 to read and/or write information. In such a case, of the protector members provided on the four end parts of the ribs 30, two protectors 4 provided on the outer edge side of the optical disk 2 may go beyond the surface of the optical disk 2. At this moment, the outer edge of the optical disk 2 goes across the rib 30, passing areas where the protectors 4 are not provided.

In such a position, when control error caused by servo instability occurs, the optical disk 2 comes into contact with the rib 30 as illustrated in FIG. 5, but the optical disk 2 do not come into direct contact with the objective lens 1. This is because the rib 30 is provided closer to the optical disk 2 than the objective lens 1 is.

Further, since the protectors 4 are provided on the end parts of the ribs 30, the protectors 4 are not provided in the vicinity of the objective lens 1. Particularly, the protectors 4 are not provided over the objective lens 1 in the direction indicated by the letter Q. Thus, even if the outer edge of the optical disk 2 comes into contact with the objective lens holding unit when control error caused by servo instability occurs in a position as illustrated in FIG. 5, the outer edge (edge part) of the optical disk does not come into contact with the protectors 4. Accordingly, the broken pieces of the protectors 4 are not attached onto the objective lens 1. That is, the event that the broken pieces of the protectors 4 attached onto the objective lens 1 cut off light outgoing from the objective lens 1 and light incoming into the objective lens 1 does not occur. Thus, an optical pickup device of the present embodiment can read and write information with accuracy.

Still further, since a hardness of the lens holder 3 is higher than that of the protector 4, the event that the lens holder 3 is cut away and the broken pieces of the lens holder 3 are attached onto the objective lens 1 does not occur.

Yet further, in such a case, as illustrated in FIG. 5, when the edge part of the optical disk 2 comes into contact with the rib 30, the edge part of the optical disk 2 might be scratched, but data of the optical disk 2 would not be corrupted. This is because there are no data areas on the edge part of the optical disk 2.

Further, the protectors 4 of the present embodiment are coating layers formed by coating. A coating method for providing the protectors 4 will be described later. Coating is very suitable to form protectors for use in objective lens driving unit including an objective lens having a small working distance since coating allows a layer thickness to be precisely controlled. The following will describe details of coating.

In case of an objective lens driving device including an objective lens with a large working distance of 1 mm to 1.2 mm, it is possible to form lens protectors by fixing members, which are formed separately from the lens holder, onto a lens holder in the vicinity of an objective lens by bonding or other method, as in Patent document 1.

However, in case of a high density optical disk-compliant objective lens driving unit including an objective lens with a small working distance of 0.1 mm to 0.3 mm, a distance between an objective lens and an optical disk (i.e. distance between a lens mounted section of a lens holder and the optical disk) and a distance between lens protectors and the optical disk must be controlled more precisely. If these distances are different from desired distances, it becomes impossible to cause the protectors to function properly. However, with a method of forming the protectors by fixing separate members onto the lens holder, it is extremely difficult to perform such a precise control.

On the contrary, an objective lens holding unit of the present embodiment, as described previously, is arranged such that the ribs 30 are provided, and the protectors 4 are provided on the surfaces of the ribs 30 facing the optical disk 2 by coating. That is, the positions of the surfaces of the protectors 4 facing the optical disk 2 in a direction of an optical axis of the objective lens 1 are determined by (i) the positions of the surfaces of the ribs 30 facing the optical disk and (ii) thickness of the protectors 4. Since the ribs 30 are provided integral with the lens holder 3, a height in the optical axis direction of the objective lens 1 can be controlled with precision. Further, since the protectors 4 are provided by coating, it is possible to adjust a thickness of the protectors 4 with precision. That is, the positions of the surfaces of the protectors 4 facing the optical disk 2 in the optical axis direction of the objective lens 1 can be adjusted precisely. Therefore, it is possible to precisely control a distance between the optical disk 2 and the protectors 4.

Further, with an arrangement in which the ribs 30 are formed integrally with the lens holder 3, it is possible to precisely control a distance between the lens mounted section 60 and the surfaces of the ribs 30 facing the optical disk in the focus direction. Thus, it is also possible to precisely control a distance between the top of the objective lens 1 and the protectors 4 in the focus direction.

As described above, since it is possible to precisely control the position of the top of the objective lens 1 and the positions of the surfaces of the protectors 4 facing the optical disk in the direction of the optical axis, an objective lens holding unit of the present embodiment can be used suitably for a read/write device including an objective lens with a small working distance.

Next, the following will describe the effect brought by the formation of the protectors 4 in the present embodiment.

The formation of the protectors by coating requires masking to prevent a leakage of a material for the protectors into the lens mounted section and other sections at the stage of forming the protectors onto the lens holder by coating.

In the conventional objective lens holding unit, the lens protectors were provided in the vicinity of an objective lens (Patent document 2). For this reason, it was necessary to prepare a masking jig processed with high accuracy in forming the conventional lens protectors by coating.

On the contrary, the protectors 4 of the present embodiment are provided away from the objective lens 1 and the lens mounted section 60. This reduces tendency of the material for the protectors to leak into the lens mounted section 60, without preparation of the masking jig processed with high accuracy.

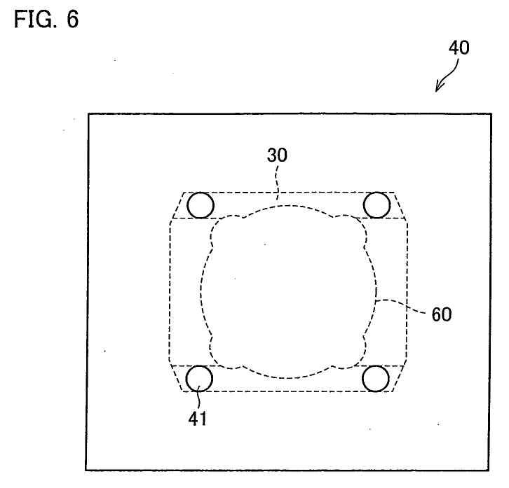

The following will describe the formation of the protectors 4 by coating in detail with reference to FIG. 6.

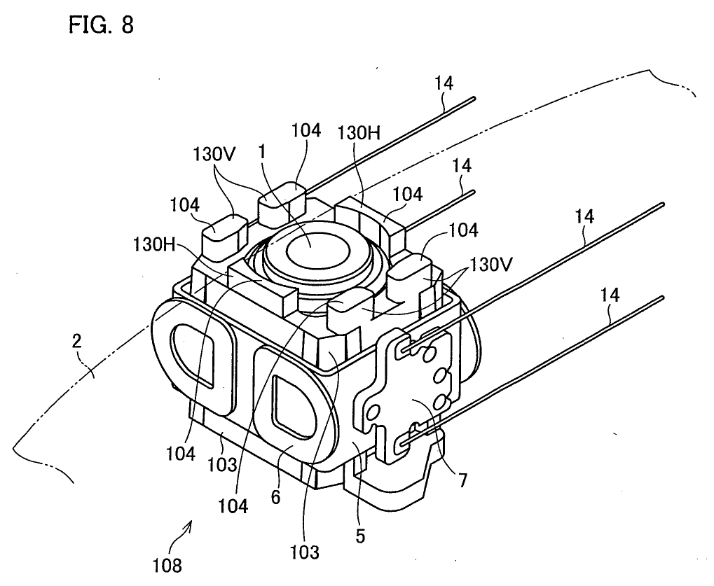

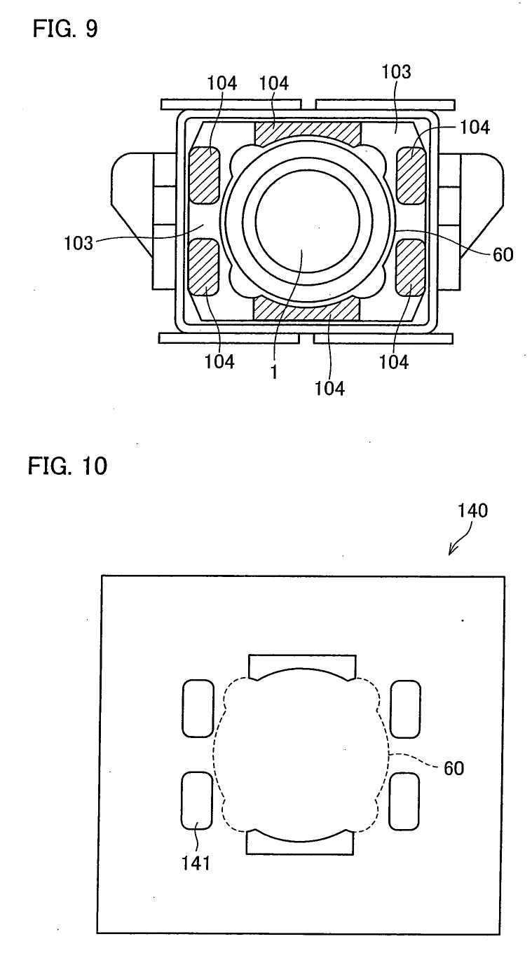

In the following descriptions, the movable part 108 illustrated in FIGS. 8 and 9 is also described as a comparative example. Comparison between the movable part 108 and the movable part 8 of the present embodiment is made to specifically describe advantageous effects of the present embodiment.

FIGS. 8 and 9 are an oblique perspective view and a plan view of the movable part 108 as a comparative example, respectively, when viewed from the optical disk 2 side. FIG. 10 is a plan view of a masking jig used in forming coating layers 104 of the movable part 108.

It is to be noted that some members of the movable part 108 can be the same members of the movable part 8. Such members are given the same reference numerals and explanations thereof are omitted here.

As illustrated in FIGS. 8 and 9, the movable part 108 includes four lens protectors 130V and two lens protectors 130H. The lens protectors 130V and the lens protectors 130H are projected independently from each other on a surface of the lens holder 103 facing the optical disk 2.

The lens protectors 130V are placed adjacent to each other in a direction of tracking driving of the objective lens 1 in such a manner that two pairs of lens protectors 130V are provided on both sides of the objective lens 1, respectively (i.e. total of four lens protectors 130V are provided). The lens protectors 130H are placed adjacent to the lens protectors 130V in a direction of the rotation of the optical disk 2 in such a manner that two lens protectors 130H are provided on both sides of the objective lens 1, respectively, so as to sandwich the objective lens 1 therebetween (i.e. total of two lens protectors 130H are provided). Further, the coating layers 104 are provided on end surfaces of the lens protectors 130V and 130H facing the optical disk (the surfaces thereof facing the optical disk).

In forming such coating layers 104, a masking jig as illustrated in FIG. 10 is needed.

The presence of a large clearance between outer shapes of the lens protectors 130V and 130H and holes 141 causes a leakage of coating material into the clearance at the time of coating. This might cause the coating material to be attached onto the lens mounted surface 60. As illustrated in FIG. 10, the coating layers 104 are formed at positions which are very close to the lens mounted section 60. If the coating material leaks into the lens mounted section 60 of the lens holder 103 and other sections, the objective lens 1 cannot be installed with stability. For this reason, the masking jig 140 must be prepared with high accuracy so as to adjust to the shapes of the lens protectors 130V and 130H. That is, the outer shapes of the lens protectors 130V and 130H must be adjusted with high accuracy to the outer shapes of the holes 141 formed on the masking jig (plate) 140.

On the contrary, as illustrated in FIG. 6, in the embodiment of the present invention, the protectors (coating layers) 4 are formed at four end parts of the ribs 30. Thus, the protectors 4 are provided away from the lens mounted section 60. This increases a degree of flexibility in adjusting the positions of the protectors 4 formed.

Hence, in order to form the protectors 4, for example, a masking jig 40 processed as illustrated in FIG. 6 and including holes taking the shape of oval 41 only needs to be prepared. This reduces the tendency of the protector material to leak into the lens mounted section 60 and other sections, without preparation of a masking jig processed with high accuracy. The reduction of the tendency of the protector material to leak enhances manufacturing yields of the objective lens holding units, thus allowing for the manufacture of the objective lens holding units at low cost.

Further, this increases a degree of flexibility in positioning the masking jig 40 with respect to the lens holder 3. Thus, it is possible to shorten the procedure and time taken to position the masking jig 40.

Still further, it is preferable that the protectors 4, as illustrated in FIG. 2, are provided outside the objective lens 1, i.e. two parallel tangents and another two tangents which are orthogonal to the parallel tangents (both of the tangents are indicated by dotted lines in FIG. 2) among all of the tangents of the effective diameter of the objective lens 1. This increases a distance from the objective lens 1. This further increases a degree of flexibility in adjusting the positions of the protectors 4 formed onto the lens holder 3.

The method described herein is only an example, and the present invention also includes coating layers formed by other methods.

The present invention is not limited to the description of the embodiments above, but may be altered by a skilled person within the scope of the claims. An embodiment based on a proper combination of technical means disclosed in different embodiments is encompassed in the technical scope of the present invention.

The present invention can be arranged as follows:

A first objective lens driving unit comprising: (i) an objective lens, which is provided so as to face an optical disk, having an optical axis perpendicular to the optical disk; (ii) a lens holder holding the objective lens; and (iii) driving means for shifting the lens holder so that the lens holder is movable in at least both a direction perpendicular to the optical disk and a radial direction of the optical disk, the driving means including: a focusing coil; a tracking coil; magnets being provided so as to face the focusing coil and the tracking coil, respectively; and yokes, the first objective lens driving unit further comprising: (iv) a pair of ribs being provided on surface of the lens holder facing the optical disk so as to be substantially perpendicular to tangential direction of the optical disk and so as to sandwich the objective lens; and protectors, which are provided on surfaces of the ribs facing the optical disk, protecting the objective lens and the optical disk from getting damaged in the event of collision between the upon the lens holder and the optical disk;

A second objective lens driving unit including the protectors formed by coating;

A third objective lens driving unit is the first objective lens driving unit including the protectors formed substantially on the end parts of the ribs;

A fourth objective lens driving unit is the first objective lens driving unit, wherein vertical positions of the ribs having the protectors provided thereon are within a working distance of the objective lens (distance between the optical disk and the top of the objective lens); and

An optical pickup device which performs at least one of (i) writing information onto an optical disk and (ii) reading information from an optical disk, the optical pickup device comprising: a light source which emits light; an objective lens; light converging means for converging light emitted from the light source onto an information storage surface of an optical disk; a first objective lens driving unit; light detecting means for detecting light reflected by the optical disk.

As described previously, an objective lens holding unit of the present invention is such that at least two ribs are provided on the surface of the lens holder facing the optical storage medium so as to sandwich the objective lens therebetween, and that the protectors are provided on the surfaces of the ribs facing the optical storage medium.

According to the above arrangement, an objective lens holding unit of the present invention can improve its stiffness thanks to the lens holder having the ribs provided thereon. Thus, it is possible to obtain stable focusing servo and tracking servo.

Thanks to the ribs, it is possible to reduce the weight of the objective lens holding unit while maintaining stiffness of the objective lens holding unit. This makes it possible for the objective lens driving unit including the foregoing objective lens to improve its driving sensitivity. As a result, it is possible to reduce power consumption.

Further, thanks to the protectors provided on the surfaces of the ribs facing the optical storage medium, it is possible to realize further weight reduction and size reduction.

Still further, the ribs are preferably provided in such a manner that longer sides thereof are substantially perpendicular to a tangential direction to an outer edge of the optical storage medium.

With the above arrangement, neither the ribs nor the protectors are provided in a radial direction of the optical storage medium with respect to the objective lens.

Thus, a read/write device including such an objective lens holding unit can directly expose a laser beam to the side surface of the objective lens from a radial direction of an optical storage medium so as to measure frequency characteristics of the objective lens. This makes it possible to accurately measure the frequency characteristics, and which brings the effect of enabling stable and accurate information reading and writing.

Yet further, the protectors are preferably coating layers formed by coating.

Coating enables control for layer thickness and enables a thin layer thickness. This makes it possible to precisely position end surfaces of the protectors facing the optical storage medium. That is, even in the case of a read/write device including an objective lens having a small working distance, the above arrangement makes it possible to reliably prevent collisions between the objective lens and the optical disk and to form compact protectors which do not scratch the optical disk.

It is preferable that the protectors are provided on both ends of longer sides of the rib.

According to the above arrangement, the protectors are away from the objective lens and the objective lens mounted section provided on the lens holder. Thus, even when the contact between the optical disk and the objective lens holding unit due to control error caused by servo instability brings the protectors into contact with the optical disk, the event is less likely to occur that portions of the protector come off due to the contact with the optical disk (broken pieces of the protectors) might be attached onto the surface of the objective lens. As a result, it is possible to perform stable and excellent reading and writing.

Further, the above arrangement reduces the tendency of the protector material to leak onto a surface where the objective lens is mounted and other sections, without preparation of a masking jig processed with high accuracy. This enhances manufacturing yields of the protectors, thus allowing for manufacturing the protectors at low cost.

It is preferable that the surfaces of the ribs facing the optical storage medium are provided between the objective lens and the optical storage medium.

With the above arrangement, the surfaces of the ribs facing the optical storage medium are provided in a working distance of the objective lens. As a result of this, even if the optical storage medium comes into contact with the objective lens holding unit in an area where the protectors are not provided, the ribs rather than the objective lens comes into contact with the optical storage medium. In other words, thanks to the ribs, it is possible to prevent the contact between the objective lens and the optical storage medium. Thus, it is possible to perform accurate and stable information reading and writing.

A lens holding device of the present invention is used suitably for a read/write device for reading and writing information from and onto the optical disk. Particularly, even in a case of a read/write device including an objective lens having a small working distance, it is possible to perform accurate and stable reading and writing.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An objective lens holding unit comprising: a lens holder which holds an objective lens so that the objective lens faces an optical storage medium, the objective lens converging light emitted from a light source onto the optical storage medium; and protectors which are provided so that surfaces of the protectors facing the optical storage medium are closer to the optical storage medium than the objective lens is,
wherein:
at least two ribs are provided on a surface of the lens holder facing the optical storage medium so as to sandwich the objective lens therebetween; and
the protectors are provided on surfaces of the ribs facing the optical storage medium.

2. The objective lens holding unit according to claim 1, wherein:
the ribs are provided so that their longer sides are substantially perpendicular to a tangential direction to an outer edge of the optical storage medium.

3. The objective lens holding unit according to claim 1, wherein:
the protectors are coating layers formed by coating.

4. The objective lens holding unit according to claim 1, wherein:
the protectors are provided on both ends of longer sides of the ribs.

5. The objective lens holding unit according to claim 1, wherein:
surfaces of the ribs facing the optical storage medium are provided between the objective lens and the optical storage medium.

6. An objective lens driving unit comprising:
an objective lens holding unit including: a lens holder which holds an objective lens so that the objective lens faces an optical storage medium, the objective lens converging light emitted from a light source onto the optical storage medium; and protectors which are provided so that surfaces of the protectors facing the optical storage medium are closer to the optical storage medium than the objective lens is, wherein: at least two ribs are provided on a surface of the lens holder facing the optical storage medium so as to sandwich the objective lens therebetween; and the protectors are provided on surfaces of the ribs facing the optical storage medium;
a movable part which is supported so as to be movable in at least two directions, focusing direction and tracking direction, with respect to the optical storage medium; and
a driving section which causes the movable part to move in at least the two directions.

7. An optical pickup device including an objective lens driving unit,
the objective lens driving unit comprising:
(i) an objective lens holding unit including: a lens holder which holds an objective lens so that the objective lens faces an optical storage medium, the objective lens converging light emitted from a light source onto the optical storage medium; and protectors which are provided so that surfaces of the protectors facing the optical storage medium are closer to the optical storage medium than the objective lens is, wherein: at least two ribs are provided on a surface of the lens holder facing the optical storage medium so as to sandwich the objective lens therebetween; and the protectors are provided on surfaces of the ribs facing the optical storage medium,
(ii) a movable part which is supported so as to be movable in at least two directions, focusing direction and tracking direction, with respect to the optical storage medium; and
(iii) a driving section which causes the movable part to move in at least the two directions.

8. A read/write device including an optical pickup device,
the optical pickup device including an objective lens driving unit,
the objective lens driving unit comprising:
(i) an objective lens holding unit including: a lens holder which holds an objective lens so that the objective lens faces an optical storage medium, the objective lens converging light emitted from a light source onto the optical storage medium; and protectors which are provided so that surfaces of the protectors facing the optical storage medium are closer to the optical storage medium than the objective lens is, wherein: at least two ribs are provided on a surface of the lens holder facing the optical storage medium so as to sandwich the objective lens therebetween; and the protectors are provided on surfaces of the ribs facing the optical storage medium,
(ii) a movable part which is supported so as to be movable in at least two directions, focusing direction and tracking direction, with respect to the optical storage medium; and
(iii) a driving section which causes the movable part to move in at least the two directions.
